(19) United States
(12) Patent Application Publication
(10) Pub. No.: US 2004/0037952 A1
(43) Pub. Date: Feb. 26, 2004

(54) Coating of surfaces, which get in contact with a liquid, for the prevention of biological fouling

(76) Inventors: Stefan Sandrock, Nienhagen (DE); Eva-Maria Scharf, Rostock (DE); Hans-Georg Neumann, Rostock (DE); Konrad Reiter, Barth (DE); Axel Franz, Kritzmow (DE); Eggert Gunther, Doberan (DE)

Correspondence Address: BIRCH STEWART KOLASCH & BIRCH, PO BOX 747, FALLS CHURCH, VA, 22040-0747, US

(21) Appl. No.: 10/321,675

(22) Filed: Dec. 18, 2002

(30) Foreign Application Priority Data
Aug. 20, 2002 (DE) 102 38 981.0

(51) Int. Cl. B41M 3/12

(52) U.S. Cl. 427/149

(57) ABSTRACT

Protecting surfaces from biological fouling when the surfaces are in contact with a liquid medium such as salt water or fresh water. The surfaces are protected by a coating comprises several layers. The layers include: a layer of electrically conductive carbon foil; and a top coating with special properties. The carbon foil is provided with an electrical contact. There is a counter electrode in the liquid medium by which a direct current can be generated to cause a shift in the pH value of the liquid layer adjacent to the surface.

### SUMMARY

The invention refers to a special coating of surfaces, which get in contact with a liquid, mainly with sea water or fresh water, for the prevention of biological fouling by changes of the pH value of the liquid layer directly surrounding the surfaces. The coating according to the invention consists of several layers, where

onto the surface to be protected (1), provided that the surface itself is electrically

conductive, at least one electrically insulating layer (2) is applied; and

onto the insulating layer (2) or the surface to be protected (1) respectively, provided that the surface itself is not electrically conductive, an electrically conductive carbon foil (4) is stuck by means of an electrically conductive adhesive coat (3); and

onto the electrically conductive carbon foil (4) a top coating (5) being water-resistant, mechanically stable and resistant to alkaline and acid pH values is applied, which makes possible a conductive connection between the adhesive (3)—carbon foil (4)—coat and the aqueous surrounding medium either by own conductivity or by micropores, which permit a certain passage of the surrounding liquid, the electrical conductivity of which is, however, smaller than that of the adhesive (3)—carbon foil (4)—coat.

The carbon foil (4) is provided with an electrical contact (6) and functions as an electrode.

There is at least one counter-electrode in the liquid surrounding medium and by applying a voltage to the electrodes an electrical direct-current field is generated. By the direct-current field, the polarity of which can be changed and which is controllable, a shift of the pH value of the liquid layer directly surrounding the surface is generated, where the direction and the amplitude of the shift of the pH value are controllable through the polarity and the current density. Changes in polarity cause variable pH values, which constitute conditions inimical to life for attaching fouling organisms and their larvae.

Areas of application of the invention are maritime shipping, port installations, hydraulic constructions, offshore structures and cooling systems.

### DESCRIPTION

The invention refers to a special coating of surfaces, which get in contact with a liquid, mainly with sea water or fresh water, for the prevention of biological fouling by periodical changes of the pH value of the liquid layer directly surrounding the surfaces.

Areas of application of the invention are maritime shipping, port installations, hydraulic constructions, offshore structures and cooling systems.

Fouling organisms which attach themselves to technically used surfaces may cause considerable impairment of functions. This way in maritime shipping higher frictional resistances are caused by barnacles, mussels and algae which cling to the ship's hull and thus a higher fuel consumption at the same speed is caused. In pipe systems carrying seawater marine fouling may cause a blockage up to an entire loss of function.

Alternative methods for the prevention of marine fouling are pursued by the development of:

paints containing silicone or Teflon, by which adhering and sticking of organisms are reduced through a modification of the surface tension (DE 2601928 B2, EP 0320716 B1, EP 0489998 A1),

ablative paints which peel off themselves in layers during sailing and thus at least partly take away the adhesion ground from the marine fouling (DT 2706181 A1),

paints functionally imitating the skin of dolphins (BROEG, H. (2001), “Whale Skin against Barnacles”, mare No. 26, June/July 2001, p. 116-119),

paints functionally imitating the skin of seals (SealCoat (2001) company brochure, sealcoats.com),

separate compartments in cooling systems in which larvae/spores of organisms are killed off in the water body by a temporary drastic increase of temperature (DE 199 21 433),

electrically conducting paints, on the surface of which toxically acting electrolytic products, particularly chlorine ions, are produced (JP 63-101464, JP 63-103789, EP 0 369 557),

and have already been applied to a limited extent.

A large-scale application of the methods mentioned has, with the exception of ablative paints and silicone coatings, not gained general acceptance yet, partly for technical and partly for cost reasons. For the electrically conducting paints, which have been well known so far, as another disadvantage an environmental loading by harmful substances being released, particularly chlorine ions, has to be mentioned.

From DE 41 09 197 C2 and DE 41 09 198 C2 a method for influencing the pH value on surfaces of solids in liquid media is well known, where a coat of a binding agent and macromolecules with free anionic and cationic groups is applied onto the molecule. In this case a direct voltage is applied to this paint film as a result of which extreme pH values are produced in a thin water layer over the paint. This method, however, has the disadvantage that the shifting of the pH value is concentrated in the place closest to the counter-electrode. Therefore this method cannot be realized in practice, because it is not suitable for an extensive application.

According to the current state of technology the prevention of marine fouling is mainly carried out with biocide-containing paints (antifoulings) or methods having a biocide effect. Their effect is based on the release of biocides into the surrounding water, which causes heavy environmental problems in areas of extensive application, such as harbours, shipyards and frequently used shipping routes.

The invention is based on the task to provide a special ecologically compatible coating of surfaces which prevents the biological fouling by changes of the pH value of the liquid layer directly surrounding the surfaces and guarantees even changes of the pH value over the entire surface. By these changes of the pH value no environmentally harmful substances, such as chlorine, shall be produced or released.

This task is realized by the coating build-up (system) according to the invention and by a method for the prevention of biological fouling.

The invention is realized according to the patent claims.

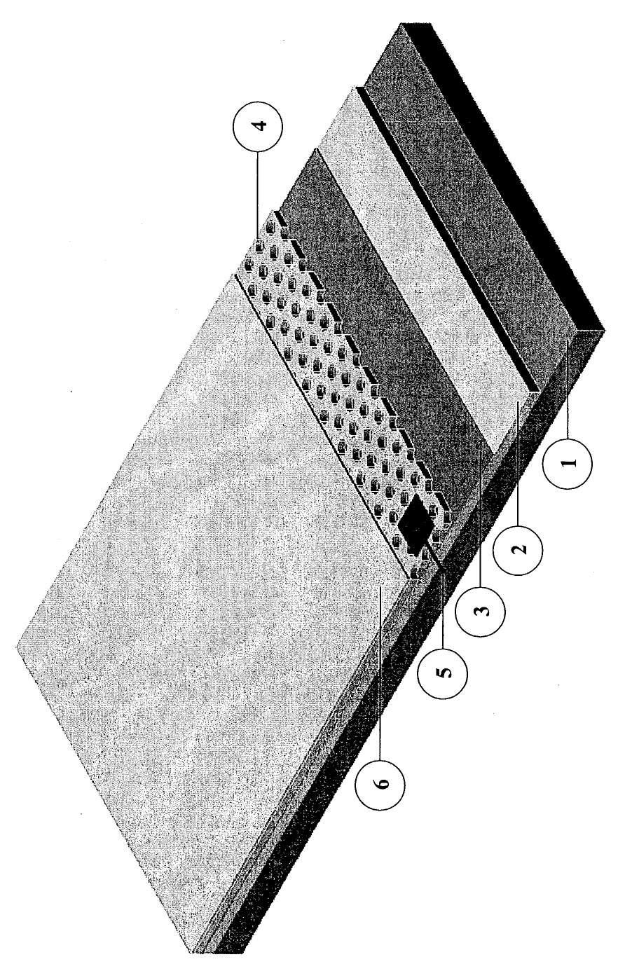

The coating according to the invention consists of several layers (FIG. 1), where

onto the surface to be protected (1), provided that the surface itself is electrically conductive, at least one electrically insulating layer (2) is applied; and

onto the insulating layer (2) or the surface to be protected (1) respectively, provided that the surface itself is not electrically conductive, an electrically conductive carbon foil (4) is stuck by means of an electrically conductive adhesive coat (3); and

onto the electrically conductive carbon foil (4) a top coating (5) being water-resistant, mechanically stable and resistant to alkaline and acid pH values is applied, which makes possible a conductive connection between the adhesive (3)—carbon foil (4)—coat and the aqueous surrounding medium either by own conductivity or by micropores, which permit a certain passage of the surrounding liquid, the electrical conductivity of which is, however, smaller than that of the adhesive (3)—carbon foil (4)—coat;

there is at least one counter-electrode in the liquid surrounding medium by which an electrical direct-current field can be generated when applying a voltage to the electrodes.

The carbon foil (4), preferably a graphite foil, is provided with an electrical contact (6) and functions as an electrode. There is at least one counter-electrode in the liquid surrounding medium and by applying a voltage to the electrodes an electrical direct-current field is generated. By the direct-current field, the polarity of which can be changed and which is controllable, a shift of the pH value of the liquid layer directly surrounding the surface is generated, where the direction and the amplitude of the shift of the pH value are controllable through the polarity and the current density.

The electrically conductive top coatings (5) preferably consist of conductive epoxy resin. According to the invention, however, also non-conductive coats can be applied which permit a certain passage of the surrounding liquid and thus ensure the electrical contact between the carbon foil (4) and the surrounding medium.

The counter-electrode may be fixed in a stationary position in the surrounding milieu, for example in the harbour, as well as in an appropriate way on the surface to be protected, for example electrically insulated on the surface of a ship's hull.

Coating may also be arranged in segments, where each segment can be activated separately. Where the electrical field is generated in segments and in succession also larger areas can be protected from biological fouling in an energy-efficient way.

Furthermore, subject matter of the invention is a method for the prevention of biological fouling with the coating according to the invention, where a voltage adjustable via a control unit is applied to the electrical contact (6) and the counter-electrode, and the voltage is so adjusted that the pH value of the liquid layer directly surrounding the surface is either above or below the pH value of the liquid. Changes in polarity effect varying pH values, where the generated pH value, which is above the normal value of the liquid, between 8 and 11, is preferably between 9 and 10; and the generated pH value, which is below the normal value of the liquid, between 2 and 6, is preferably between 3 and 4.

The duration of the pH value change is 1-10 minutes each, preferably 4 minutes.

Between the changes of the pH value rests are made during which no electrical field is applied and which preferably last for 1-30 minutes, where the rests between the first, third, fifth, seventh, etc. shift last for 1-5 minutes, preferably 2 minutes; and the rests between the second, fourth, sixth, eighth, etc. shift last for 5-30 minutes, preferably 15 minutes.

In contrast to the methods described in DE 41 09 197 C2 and DE 41 09 198 C2, the special layer build-up of the coating according to the invention and the claimed method make an even distribution of the pH value changes possible over the entire area to be protected.

The coating according to the invention and the method are thus in the position to create inimical conditions for fouling organisms and their larvae without polluting the environment, and are suitable for a large-scale application, also for large areas.

As possible fields of application all areas of sport boat and professional shipping, offshore structures, marine structures and port installations, cooling systems and devices for a continuous acquisition of measured data in the aquatic area come into consideration.

In the following the invention is explained in detail by means of an example of execution.

Onto a ship's shell plating 1 coat of primer and 3 coats of 2-K epoxy resin with a total coating thickness of 300 μm are applied for the purpose of anti-corrosion protection and electrical insulation. The further coating build-up consists of:

an adhesive coat of conductive epoxy resin (50 μm),

a perforated graphite foil, hole size 2 mm (200 μm),

2 top coatings of conductive epoxy resin (100 mm).

The graphite foil is brought into contact with a self-adhesive copper foil. A graphite electrode is used as counter-electrode. The voltage applied ranges between +/−2 V and +/−10 V.

The switching rhythm, referring to the surface to be protected, is composed of: 4 min cathodic, 2 min rest, 4 min anodic, 15 min rest, 4 min cathodic, etc. The pH value registered on the surface with a microelectrode is ranging, following the switching rhythm depending on the voltage applied, between 3.5 and 10.

Legend referring to the figure:

1—surface to be protected

2—electrically insulating layer

3—electrically conductive adhesive coat

4—carbon foil

5—electrically conductive top coating

1. Coating of surfaces, which get in contact with a liquid, mainly with sea water or fresh water, for the prevention of biological fouling by periodical changes of the pH value of the liquid layer directly surrounding the surfaces, being characterized by the fact that
the surface coating consists of several layers, where
onto the surface to be protected (1), provided that the surface itself is electrically
conductive, at least one electrically insulating layer (2) is applied; and
onto the insulating layer (2) or the surface to be protected (1) respectively, provided that the surface itself is not electrically conductive, an electrically conductive carbon foil (4), preferably graphite foil, is stuck by means of an electrically conductive adhesive coat (3); and
onto the electrically conductive carbon foil (4) a top coating (5) being water-resistant, mechanically stable and resistant to alkaline and acid pH values is applied, which makes possible a conductive connection between the adhesive (3)—carbon foil (4)—coat and the aqueous surrounding medium either by own conductivity or by micropores, which permit a certain passage of the surrounding liquid, the electrical conductivity of which is, however, smaller than that of the adhesive (3)—carbon foil (4)—coat;
the carbon foil (4)-coat is provided with an electrical contact (6); and
there is at least one counter-electrode in the liquid surrounding medium by which an electrical direct-current field can be generated when applying a voltage to the electrodes and the polarity of which can be changed and which is controllable, and which generates a shift of the pH value in the liquid layer directly surrounding the surface, where the direction and the amplitude of the shift of the pH value are controllable through the polarity and the current density.

2. Coating according to claim 1, being characterized by the fact that
the carbon foil (4) is provided with holes; and
is embedded in a conductive polymer functioning as an adhesive coat (3).

3. Coating according to claims 1-2, being characterized by the fact that
the insulating layer (2) consists of at least one, preferably 3 polymer coats, preferably 2-K epoxy resin; and
the conductive adhesive coat (3) consists of a conductive polymer; and
the carbon foil (4) is provided with holes; and
the combination of the conductive adhesive coat (3) and the perforated carbon foil (4) may be replaced by a carbon layer applied by spraying, roller-coating or painting.
the top coating (5) consists of at least one, preferably 2 coats of conductive polymer and/or polymer coats which have micropores; and

4. Coating according to claims 1-3, being characterized by the fact that
the top coating (5) consists of a polymer filled with graphite and/or soot.

5. Coating according to claims 1-4, being characterized by the fact that
a self-adhesive copper foil is used as an electrical contact (6).

6. Coating according to claims 1-5, being characterized by the fact that
a graphite electrode or ferrosilicon electrode is used as a counter-electrode.

7. Coating according to claims 1-6, being characterized by the fact that
a voltage, which is adjustable via a control unit, is applied to the electrical contact (6) and the counter-electrode.

8. Method for the prevention of biological fouling with a coating according to claims 1-7, being characterized by the fact that
a voltage adjustable via a control unit is applied to the electrical contact (6) and the counter-electrode, where the voltage is so adjusted that the pH value of the liquid layer directly surrounding the surface is differing from the original pH value of the liquid either in basic or in acid direction.

9. Method according to claim 8, being characterized by the fact that alternately
pH values are produced which are above the normal value of the liquid; and
pH values are produced which are below the normal value of the liquid.

10. Method according to claims 8 and 9, being characterized by the fact that
the produced pH value, which is above the normal value of the liquid, is ranging between 8 and 11, preferably between 9 and 10; and
the produced pH value, which is below the normal value of the liquid, is ranging between 2 and 6, preferably between 3 and 4.

11. Method according to claims 8-10, being characterized by the fact that
the duration of the change of the pH value is 1-10 minutes each, preferably 4 minutes.

12. Method according to claims 8-11, being characterized by the fact that
between the changes of the pH value rests are made during which no electrical field is applied and which preferably last for 1-30 minutes.

13. Method according to claims 8-12, being characterized by the fact that
between the changes of the pH value rests are made during which no electrical field is applied, where the rests between the first, third, fifth, seventh, etc. shift last for 1-5 minutes, preferably 2 minutes; and the rests between the second, fourth, sixth, eighth, etc. shift last for 5-30 minutes, preferably 15 minutes.

14. Method according to claims 8-13, being characterized by the fact that
the application of the electrical field and the change of the pH value of the liquid layer directly surrounding the surfaces are carried out in segments and individually in succession.
